(19) United States
(12) Patent Application Publication
(10) Pub. No.: US 2008/0097014 A1
(43) Pub. Date: Apr. 24, 2008

(54) Non-Halogen Flame Retardant and Highly Heat Resistant Phosphorous-Modified Epoxy Resin Compositions

(76) Inventors: Chong-Soo Park, Seoul (KR); Choong-Ryul Lim, Seoul (KR); Jae-Ho Choi, Seoul (KR); Bong-Goo Choi, Seoul (KR); Tae-Kyoo Shin, Gyeonggi-do (KR); Eun-Yong Lee, Gyeonggi-do (KR)

Correspondence Address: BACON & THOMAS, PLLC, 625 SLATERS LANE, FOURTH FLOOR, ALEXANDRIA, VA, 22314, US

(21) Appl. No.: 11/886,126

(22) PCT Filed: Mar. 10, 2006
(86) PCT No.: PCT/KR06/00863

§ 371 Date: Sep. 11, 2007

(30) Foreign Application Priority Data
Mar. 11, 2005 (KR) 10-2005-0020506

(51) Int. Cl. C09K 21/12; C08K 3/40; C08K 5/1545; C08L 71/02

(52) U.S. Cl. 524/110

(57) ABSTRACT

Disclosed is a non-halogen type highly heat resistant flame retardant epoxy resin composition that is made by compounding a phosphorous-modified epoxy resin with a phosphazene compound as a flame retardant additive, wherein the phosphorous-modified epoxy resin is obtained by reacting a phosphorous-containing compound with an epoxy resin. The non-halogen flame retardant and highly heat resistant phosphorous-modified epoxy resins according to the present invention have the excellent flame retardancy property and the good thermal property without halogen and thus can be advantageously utilized in manufacturing a printed circuit board (PCB) and for complex materials.

### TECHNICAL FIELD

The present invention relates to epoxy resin compositions, and more particularly, to non-halogen flame retardant and highly heat resistant epoxy resin compositions. The compositions of the invention have high heat resistance and provide an environment-friendly epoxy resin having excellent physical properties by achieving the flame retardancy using non-halogen type materials.

### BACKGROUND ART

Currently, flame retardant plastic materials that are not burned in heat or flame are required in various industrial fields such as electric devices, transport facilities and construction materials. In particular, it is necessary for the plastic materials used in the electric devices such as printed circuit board and the like to have high heat resistance in view of features of the product. However, it is not so easy to satisfy the processability during the manufacturing process or other physical properties of the products while obtaining a satisfactory heat resistance and flame retardancy.

There are known the compounds of the elements of the group V or the group VII of the Periodic Table as the materials showing the flame retardant effect. For example, halogen, phosphorus, antimony compounds and the like are known to be the most effective flame retardants. The halogen compounds are aliphatic, aromatic or alicyclic compounds having the substituted bromine or chlorine and show the superior flame retardant effect. Especially, bromine is known to have better flame retardant effect than chlorine. This is because the binding strength between carbon and bromine (65 kcal/mol) is weaker than that between carbon and chlorine (81 kcal/mol), and thus, the bromine containing compounds are easily decomposed in combustion thereof, which produce bromine compounds of a low molecular weight showing the flame retardant effect.

For the flame retardant effect of the epoxy resin, a bromine-containing flame retardant is also mainly used; and the phosphorous-containing flame retardant system, halogen (bromine)- and phosphorous-containing flame retardant system are widely utilized. For example, Korean patent publication number 1995-6533 discloses N-tribromophenylmaleimide as a flame retardant system that reacts with a polymer substrate.

A phosphorous-containing flame retardant system is preferred to halogen-, especially bromine-containing flame retardant system in the environmental aspects. For example, Korean Patent Number 215639 describes a red-phosphorus flame retardant system in the form of additive type. Japanese Patent Laid-open Publication Number Hei 4-11662 discloses a system that obtains the flame retardant effect by reacting 2-(6-oxide-6-H-dibenzo<c,e><1,2>oxa phosphorin-6-yl) 1,4-benzenediol with a polymer resin as reaction type.

Furthermore, Korean Patent Number 425376 (phosphorous- and silicone-modified flame retardant epoxy resin) issued to the applicant of the present application discloses a phosphorous- and silicone-modified epoxy resin showing the excellent flame retardancy. This patent teaches that the flame retardancy of phosphorous-modified epoxy resin can be enhanced by reacting the epoxy resin with phosphorous and silicone.

### DISCLOSURE OF INVENTION

### Technical Problem

The present invention discloses the epoxy resin composition having the excellent heat resistance and flame retardancy. The composition comprises basically a flame retardant system, as a non-halogen type flame retardancy, which reacts a known phosphorous compound, 2-(6-oxide-6-H-dibenzo<c,e><1,2>oxa phosphorin-6-yl) 1,4-benzenediol with an epoxy resin having the excellent heat resistance, and further suitable flame retardant additives with an optimal content ratio of each component to provide the heat resistance, flame retardancy and proper viscosity that are suitable for copper clad laminate for manufacturing the printed circuit board.

### Technical Solution

The present invention has been made in view of the background as set forth above, and it is, therefore, an object of the present invention to provide a non-halogen type highly heat resistant flame retardant system. Specifically, it is an object of the present invention to provide the epoxy resin compositions having the excellent flame retardant effect, suitable viscosity range and good heat resistance without halogen by adding a phosphazene compound, as a flame retardant additive, to a phosphorous-modified epoxy resin obtained by reacting a known phosphorous-containing compound with an epoxy resin having the excellent heat resistance.

The object of the invention can be accomplished by providing a non-halogen flame retardant and highly heat resistant epoxy resin. That is, the present invention provides novel non-halogen flame retardant and highly heat resistant phosphorous-modified epoxy resin compositions by adding flame retardant additives including phosphazene group in its molecular structure to a phosphorous-modified epoxy resin, to provide the flame retardant synergy effect, manufactured by reacting a known phosphorous compound, 2-(6-oxide-6-H-dibenzo<c,e><1,2>oxa phosphorin-6-yl) 1,4-benzenediol with a novolak type epoxy resin having the excellent heat resistance. The final epoxy resin composition according to the present invention can be used for manufacturing the environment-friendly printed circuit board and for complex materials as highly heat resistant non-halogen type flame retardant system.

More specifically, the novel non-halogen flame retardant and highly heat resistant phosphorus type epoxy resin composition of the present invention is characterized in that the non-halogen type flame retardant and highly heat resistant phosphorous-modified epoxy resin composition (C) is made by adding, to a phosphorous-modified epoxy resin (A) obtained by reacting a phenol novolak type epoxy resin, ortho cresol novolak type epoxy resin or BPA novolak type epoxy resin with a compound having a constitution unit of formula (I) below, a phosphazene compound (B), wherein the phosphorous content in said phosphorous-modified epoxy resin (A) is 1.5 wt % or less and the phosphorous content of said epoxy resin composition (C) ranges from 1.5 wt % to 5.0 wt %.

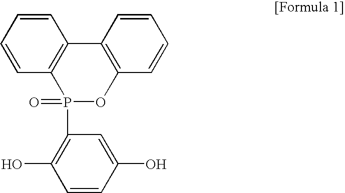

Hereinafter, the present invention will be described in detail.

The reactive phosphorous-containing compounds used in the present invention is 2-(6-oxide-6-H-dibenzo<c,e><1,2>oxa phosphorin-6-yl) 1,4-benzenediol (hereinafter, referred to as ‘ODOPB’) of formula (1) and used often as an alternative material to the bromine type flame retardant in terms of the environmental consideration. This ODOPB reacts with an epoxy group and thus creates the phosphorous-modified epoxy resin. In the present invention, the epoxy resin that reacts with ODOPB is phenol novolak type epoxy resin, ortho cresol novolak type epoxy resin, or BPA novolak type epoxy resin; and preferably phenol novolak type epoxy resin. Such an ODOPB is known for use as the flame retardant by reaction with general epoxy resins. Thus, although those skilled in the art could expect that the novolak type epoxy resin is selected and used as the epoxy resin to enhance the heat resistance, the ODOPB that reacts with the phenol novolak type epoxy resin, ortho cresol novolak type epoxy resin and BPA novolak type epoxy resin cannot be used in a sufficient amount to achieve a desired level of the flame retardant effect due to the multi-functionality of those epoxy resins. This is because if the amount of ODOPB used is increased to obtain the desired level of the flame retardant performance, such ODOPB is subject to gellation owing to its reaction with the epoxy resin. Therefore, even if the novolak type epoxy resin is used for the heat resistance, it is necessary to properly control the reaction with the epoxy resin in order to prevent an increase in the viscosity. Even so, the target physical properties such as the heat resistance, flame retardancy and the like should be of course maintained at the desirable level.

The inventors who had recognized the above point from before found from extensive researches that it is possible to obtain the heat resistance and flame retardant performance at the desirable level while preventing abrupt increase in the viscosity by controlling (distributing) suitably phosphorous content inside or outside the molecular chain of the epoxy resin. Thus, the inventors devised the present invention. In other words, the inventors found the fact that the desired heat resistance and flame retardant performance while preventing the abrupt increase in the viscosity can be achieved by dividing the phosphorus component in the resin composition that exhibits the flame retardancy into one phosphorous compound that reacts with the epoxy resin and the other phosphorous compound that does not react with the epoxy resin and then controlling these two compounds appropriately.

From an in-depth study, the present inventors found that the ODOPB, which reacts with the phenol novolak type epoxy resin, ortho cresol novolak type epoxy resin or BPA novolak type epoxy resin in the epoxy resin composition of the present invention, has to be in such an amount that the phosphorous content in the phosphorous-modified epoxy resin (A) is 1.5 wt % or less. However, such phosphorous content itself is not sufficient for the desired flame retardant effect. If the phosphorous content is controlled only by the amount of the ODOPB participated in the reaction, the viscosity of the product increases (if the phosphorus content is more than 1.5 wt %, the flame retardant effect becomes higher, but the viscosity of the product increases dramatically to thereby make the possibility of its gellation significantly greater), whereby it is difficult to control the resin rheology in using in the laminated board for the circuit board. Therefore, it was found that the final phosphorous content in the phosphorous-modified epoxy resin composition (C) has to be within the range of 1.5 wt % to 5.0 wt %, and preferably 1.5 wt % to 2.5 wt % by adding the phosphazene compound (B) as the flame retardant additive.

As ODOPB used in the present invention, there is HCA-HQ (commercially available from Samkwang Chemical Co., Ltd. of Japan), DPP-HQ (commercially available from IDB Corporation of Korea) or the like.

A method for manufacturing the compounds containing the phosphazene group (—P═N—) used in the present invention and its types are disclosed in Korean Patent Application Number 10-2004-70013051 and the compounds containing the phosphazene group include SPB-100 (commercially available from Otsuka Pharmaceuticals Co., Ltd. of Japan) for example.

The reaction of the epoxy resin with the ODOPB is carried out at a reaction temperature of 140 to 190? in the presence of a catalyst such as phosphorus, imidazole, tertiary amine or the like for 3 to 8 hours.

The epoxy resin used in the present invention is the phenol novolak type epoxy resin, the ortho cresol novolak type epoxy resin, or the BPA novolak type epoxy resin; and preferably the phenol novolak type epoxy resin.

The non-halogen flame retardant and highly heat resistant phosphorous-modified epoxy resin (C) is finally made by adding the phosphazene compound (B) as the flame retardant additive to the phosphorous-modified epoxy resin (A) (the phosphorous content: 1.5 wt % or less) obtained by reacting the epoxy resin with the ODOPB. The amount of the flame retardant additive phosphazene compound (B) added to the phosphorous-modified epoxy resin composition (A) should be set to satisfy that the phosphorous content in the final epoxy resin composition (C) is 1.5 wt % to 5.0 wt %, and preferably 1.5 wt % to 2.5 wt %.

The epoxy resin composition (C) of the present invention is cured by a hardening agent. The hardening agent used in the present invention includes generally known materials, for example, acid anhydride, polyamide, amine, phenol novolak, cresol novolak and the like, wherein dicyandiamide, diaminodiphenylmethane, diaminodiphenylsulfone and the like are primarily used. Furthermore, the epoxy resin composition (C) of the present invention can comprise other additives known in the art, which have filler, pigment, colorant and the like, together with the hardening agent depending on its usage.

The epoxy resin composition (C) in the present invention can be utilized in manufacturing Copper Clad Laminates (CCL) for the printed circuit board and for complex materials. The copper clad laminates for the printed circuit board are fabricated by preparing one or more laminates comprising a prepreg for manufacturing the copper clad laminate comprising the epoxy resin composition (C) of 35 wt % to 60 wt % and a glass fiber of 40 wt % to 65 wt % and integrating the laminates by heating and pressing the outer layers of copper clad located outside the laminates.

### MODE FOR THE INVENTION

Examples of the present invention will now be described in detail below.

### Example 1

111.11 g of ODOPB (available from IDB Corporation, DPP-HQ) was bulk-polymerized in 1000 g of YDPN-638 (which is a phenol novolak type epoxy resin available from Kukdo Chemical Co., Ltd., EEW: 180 g/eq) using ETPPI (Ethyltriphenylphosphonium Iodide, available from SINOCHEM) as a catalyst at a reaction temperature of 160° C. for 3 hours to manufacture a phosphorous-modified epoxy resin (A) (phosphorous content: 0.96 wt %).

105 g of SPB-100 (available from Otsuka Pharmaceuticals Co., Ltd., Japan) was stirred in this phosphorous-modified epoxy resin (A) at 110° C. for 1 hour to obtain the epoxy resin (C) (EEW: 263.18 g/eq) having the phosphorous content of 2 wt % of the total product.

### Example 2

111.11 g of ODOPB was bulk-polymerized in 1000 g of YDPN-638 (which is a phenol novolak type epoxy resin) using ETPPI as a catalyst at a reaction temperature of 160° C. for 3 hours to make a phosphorous-modified epoxy resin (A) (phosphorous content: 0.96 wt %).

52.48 g of SPB-100 was stirred in this phosphorous-modified epoxy resin (A) at 110° C. for 1 hour to obtain the phosphorous-modified epoxy resin (B) (EEW: 263.10 g/eq) having the phosphorous content of 1.5 wt % of the total product.

### Example 3

111.11 g of ODOPB was bulk-polymerized in 1000 g of YDPN-638 (which is a phenol novolak type epoxy resin) using ETPPI as a catalyst at a reaction temperature of 160° C. for 3 hours to produce a phosphorous-modified epoxy resin (A) (phosphorous content: 0.96 wt %).

227.02 g of SPB-100 was stirred in this phosphorous-modified epoxy resin (A) at 110° C. for 1 hour to obtain the phosphorous-modified epoxy resin (C) (EEW: 288.60 g/eq) having the phosphorous content of 3.0 wt % of the total product.

### Example 4

111.11 g of ODOPB was bulk-polymerized in 1000 g of YDPN-638 (which is a phenol novolak type epoxy resin) using ETPPI as a catalyst at a reaction temperature of 160° C. for 3 hours to manufacture a phosphorous-modified epoxy resin (A) (phosphorous content: 0.96 wt %).

240.54 g of SPB-100 was stirred in this phosphorous-modified epoxy resin (A) at 110° C. for 1 hour to obtain the phosphorous-modified epoxy resin (C) (EEW: 294.54 g/eq) having the phosphorous content of 3.1 wt % of the total product.

### Example 5

52.63 g of ODOPB was bulk-polymerized in 1000 g of YDPN-638 (which is a phenol novolak type epoxy resin) using ETPPI as a catalyst at a reaction temperature of 160° C. for 3 hours to provide a phosphorous-modified epoxy resin (A) (EEW: 210.03 g/eq) having the phosphorous content of 0.48 wt % of the total product.

### Example 6

111.11 g of ODOPB was bulk-polymerized in 1000 g of YDPN-638 (which is a phenol novolak type epoxy resin) using ETPPI as a catalyst at a reaction temperature of 160° C. for 3 hours to make a phosphorous-modified epoxy resin (A) (EEW: 241.82 g/eq) having the phosphorous content of 0.96 wt % of the total product.

### Example 7

176.47 g of ODOPB was bulk-polymerized in 1000 g of YDPN-638 (which is a phenol novolak type epoxy resin) using ETPPI as a catalyst at a reaction temperature of 160° C. for 3 hours to provide a phosphorous-modified epoxy resin (A) (EEW: 278.98 g/eq) having the phosphorous content of 1.43 wt % of the total product.

### Example 8

250 g of ODOPB was bulk-polymerized in 1000 g of YDPN-638 (which is a phenol novolak type epoxy resin) using ETPPI as a catalyst at a reaction temperature of 160° C. for 3 hours to produce a phosphorous-modified epoxy resin having the phosphorous content of 1.91 wt % of the total product. However, the resultant resin was gellated.

### Example 9

111.11 g of ODOPB was bulk-polymerized in 1000 g of YDCN-500-10P (which is an ortho-cresol novolak type epoxy resin, available from Kukdo Chemical Co., Ltd., EEW: 206 g/eq) using ETPPI as a catalyst at a reaction temperature of 160° C. for 3 hours to make a phosphorous-modified epoxy resin (A) (phosphorous content: 0.96 wt %).

105 g of SPB-100 was stirred in this phosphorous-modified epoxy resin (A) at 110° C. for 1 hour to manufacture the phosphorous-modified epoxy resin (C) (EEW: 276.54 g/eq) having the phosphorous content of 2 wt % of the total product.

### Example 10

111.11 g of ODOPB was bulk-polymerized in 1000 g of KBPN-110 (which is a BPA novolak type epoxy resin, available from Kukdo Chemical Co., Ltd., EEW: 210 g/eq) using ETPPI as a catalyst at a reaction temperature of 160° C. for 3 hours to provide a phosphorous-modified epoxy resin (A) (phosphorous content: 0.96 wt %).

105 g of SPB-100 was stirred in this phosphorous-modified epoxy resin (A) at 110° C. for 1 hour to obtain the phosphorous-modified epoxy resin (C) (EEW: 280.59 g/eq) having the phosphorous content of 2 wt % of the total product.

### Example 11

111.11 g of ODOPB was bulk-polymerized in 1000 g of YDPN-638 (which is a phenol novolak type epoxy resin) using ETPPI as a catalyst at a reaction temperature of 160° C. for 3 hours to make a phosphorous-modified epoxy resin (A) (phosphorous content: 0.96 wt %).

561.55 g of SPB-100 was stirred in this phosphorous-modified epoxy resin (A) at 110° C. for 1 hour to obtain the phosphorous-modified epoxy resin (C) (EEW: 364.15 g/eq) having the phosphorous content of 5.0 wt % of the total product.

### Example 12

111.11 g of ODOPB was bulk-polymerized in 1000 g of YDPN-638 (which is a phenol novolak type epoxy resin) using ETPPI as a catalyst at a reaction temperature of 160° C. for 3 hours to produce a phosphorous-modified epoxy resin (A) (phosphorous content: 0.96 wt %).

600 g of SPB-100 was stirred in this phosphorous-modified epoxy resin (A) at 110° C. for 1 hour to obtain the phosphorous-modified epoxy resin (C) (EEW: 368.37 g/eq) having the phosphorous content of 5.18 wt % of the total product.

Hardening of the Epoxy Resin and the Fabrication of the Prepreg

To test the flame retardancy of the epoxy resins manufactured in the above Examples, the hardening reaction was conducted by using dicyandiamide (the amount of the used dicyandiamide (g)=12.6/epoxy equivalent weight×100) as a hardening agent and 2-Methyl Imidazole (3.3 phr for the dicyandiamide) as a hardening accelerator.

The prepreg was processed at 175° C. for 3 minutes to a semi-cured state and then the 8-layered specimen was pressed at 175° C. under the pressure of 25 kgf/cm² for 30 minutes followed by applying the pressure of 50 kgf/cm² for 30 minutes and cooling for 15 minutes with a coolant.

The flame retardancy tests were performed on the quintet specimens of the respective examples according to the UL-94 rating.

The results are shown in the table below.

| | | | Phosphorous- | | | | |
|---|---|---|---|---|---|---|---|
| | | | content in | | | | |
| | Equiv- | | phosphorous- | | | Final | Flame |
| | alent | Viscos- | modified | | Gel time | phosphorous- | retardancy |
| Exam. | weight | ity | epoxy resin | Tg | [sec | content | [UL-94 |
| No. | (g/eq) | @25° C.⁽¹⁾ | (A)(wt %) | (° C.)⁽²⁾ | @150° C.] | (wt %) | rating] |
| 1 | 263.18 | 16600 | 0.96 | 173.08 | 77 | 2.0 | V-0 |
| 2 | 263.10 | 18200 | 0.96 | 174.71 | 78 | 1.5 | V-0 |
| 3 | 288.60 | 6400 | 0.96 | 172.97 | 87 | 3.0 | V-0 |
| 4 | 294.54 | 6000 | 0.96 | 172.26 | 94 | 3.1 | V-0 |
| 5 | 210.03 | 4100 | 0.48 | 175.00 | 82 | 0.48 | x |
| 6 | 241.82 | 21000 | 0.96 | 175.18 | 78 | 0.96 | V-2 |
| 7 | 278.98 | 34000 | 1.43 | 177.49 | 69 | 1.43 | V-1 |
| 8⁽³⁾ | — | — | — | — | — | 1.91 | — |
| 9 | 276.54 | 23000 | 0.96 | 181.02 | 57 | 2.0 | V-0 |
| 10 | 280.59 | 22000 | 0.96 | 179.26 | 65 | 2.0 | V-0 |
| 11 | 364.15 | 5100 | 0.96 | 171.35 | 105 | 5.0 | V-0 |
| 12 | 368.37 | 5030 | 0.96 | 169.59 | 113 | 5.18 | V-0 |
| Comp. | 450.8 | 1800 | — | 140 | 175 | 20.22⁽⁴⁾ | V-0 |
| Exam. 1 | | | | | | | |

(1) The viscosity was measured after the specimen was solved in a solvent (Methyl Cellosolve) of 20 wt % on the basis of the total weight.

(2) DSC

(3) Gellation in the synthesis step

(4) Br content

In Comparative Example 1, DIM-10 (which is a brominated epoxy resin available from Kukdo Chemical Co., Ltd., bromine content: 20%) was cured by dicyandiamide, and then tested for the flame retardancy in the same way as the examples described above.

As shown in Table above, if the phosphorous content is less than the appropriate level (Example 5), no flame retardancy was observed. Meanwhile, if the phosphorous content is 1.5 wt % or more, the superior flame retardancy of V-0 rating was obtained. However, if the phosphorous content in the phosphorous-modified epoxy resin (A) was increased only with the ODOPB (phosphorous content: 1.5 wt % or more), the heat resistance was enhanced (more than 170° C.) but the resin was gellated (Example 8). Meanwhile, if the phosphorous content of the final epoxy resin was increased by adding the flame retardant additive, phosphazene compound, after the phosphorous content in the epoxy resin (A) was made to 1.5 wt % or less by using the ODOPB, the flame retardant effect was improved. Furthermore, if the phosphorous content in the final epoxy resin (C) was increased by adding the phosphazene compound in the final epoxy resin (C), it showed a tendency that the flame retardant effect was enhanced in proportion to such phosphorous content increase whereas the heat resistance is deteriorated. Namely, if the phosphorous content in the epoxy resin becomes 5 wt % or more by the phosphazene compound, the flame retardant effect in the epoxy resin is maintained as V-0 rating, but the heat resistance is decreased below 170° C. (Example 12). Therefore, to satisfy both the heat resistance of 170° C. or more and the flame retardancy of V-0 rating, it needs to control the phosphorous content within the range disclosed in the present invention.

### INDUSTRIAL APPLICABILITY

As described above, the non-halogen flame retardant and highly heat resistant phosphorous-modified epoxy resins according to the present invention have the excellent flame retardancy and the good thermal and electrical properties without halogen and thus can be utilized in manufacturing the printed circuit board and for complex materials.

1. A non-halogen flame retardant and highly heat resistant phosphorus-modified epoxy resin composition that is characterized in that the non-halogen type flame retardant and highly heat resistant phosphorous-modified epoxy resin composition (C) is made by adding, to a phosphorous-modified epoxy resin (A) obtained by reacting a phenol novolak type epoxy resin, ortho cresol novolak type epoxy resin or BPA novolak type epoxy resin with a compound having a constitution unit of formula (1) below, a phosphazene compound (B), wherein the phosphorous content in said phosphorous-modified epoxy resin (A) is 1.5 wt % or less and the phosphorous content of said epoxy resin composition (C) ranges from 1.5 wt % to 5.0 wt %.

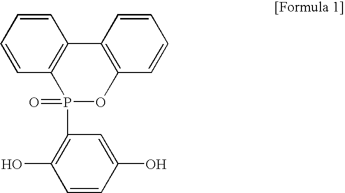

2. A prepreg for manufacturing a copper clad laminate, which comprises an epoxy resin composition (C) according to claim 1 of 35 wt % to 60 wt % and a glass fiber of 40 wt % to 65 wt %.

3. A copper clad laminates for a printed circuit board that is fabricated by integrating one or more laminates comprising the prepreg according to claim 2 with outer layers of a copper clad located outside the laminates through heating and pressing.
